(19) United States
(12) Patent Application Publication
(10) Pub. No.: US 2011/0275343 A1
(43) Pub. Date: Nov. 10, 2011

(54) WIRELESS EMERGENCY BREAKER BEACON FOR USE WITH WIRELESS TELECOMMUNICATION DEVICES

(76) Inventor: Kevin Paul Kollar, Pottstown, PA (US)

(21) Appl. No.: 12/916,746

(22) Filed: Nov. 1, 2010

Related U.S. Application Data
(60) Provisional application No. 61/331,935, filed on May 6, 2010.

(51) Int. Cl. H04M 11/04

(52) U.S. Cl. 455/404.2; 455/404.1

(57) ABSTRACT

A security services method for a wireless device, and related wireless devices, are disclosed. A security triggering event is monitored within the wireless device. This triggering event may be one or more of unauthorized loss of main battery power, activation of an emergency button on the wireless device or destructive tampering of the wireless device. In response to the security triggering event the device enters into an emergency beacon mode. While in the emergency beacon mode the device first contacts emergency services and then sends an emergency beacon message to the emergency services. In preferred embodiments the device also obtains its current location and then uses the current location to construct at least a portion of the emergency beacon message.

### CROSS-REFERENCE TO RELATED APPLICATIONS

This application claims the benefit of U.S. Provisional Application 61/331,935 filed on May 6, 2010, the teachings of which are incorporated herein by reference.

### FIELD OF THE INVENTION

The present invention relates generally to telecommunication devices. More particularly, the present invention discloses an emergency beacon system that is suitable for portable telecommunication devices.

### BACKGROUND OF THE INVENTION

Currently there are numerous companies that carry numerous devices for the use of Personal Wireless Telecommunication. In all cases in order to reach emergency services, a three digit code needs to be entered, as well as waiting for emergency services to answer the call, and the need to describe what is happening during that emergency. There is also a device in the marketplace designed for this instance, however, it is not integrated into specific mainstream Personal Wireless Telecommunication devices. It is a stand alone device with the sole purpose of being used in emergency situations. It is flawed in the fact that it is a one-touch auto-dial to emergency services, however a person in an emergency still has to make voice contact with emergency services personnel. In none of the prior art devices is there a system based on the Personal Wireless Telecommunication device being activated by sudden loss of power, nor are any able to transmit the fact that there is an emergency and be able to give GPS coordinates automatically. There are also systems built into automobiles to communicate an emergency, however, these are not portable and hand held, and in addition, the person who has this device needs to subscribe to a service that monitors their system. In this case, if there were an emergency, everything would need to go through a call center, and then on to emergency services. In all prior art devices the fact simply is in order for them to function, they must have the primary power intact.

Accordingly, there is an immediate need for improved telecommunications devices that can aid a user in the event of a life-threatening emergency.

### SUMMARY OF THE INVENTION

Various embodiments give people an edge in life-threatening situations by providing a one-touch, automatic communication with emergency services during, or prior to, an emergency event taking place. Embodiment systems also activate upon non-security pin entered battery removal, or, if applicable, the hinge being broken from the device itself. Embodiment systems may activate with one of three disabling events (either pressing the button/switch/breaker, sudden removal of the main battery without a personal security pin input prior to removal, or the hinge on the telecommunication device being broken away from the device, if applicable).

In one aspect a security services method for a wireless device is disclosed. A security triggering event is monitored within the wireless device. This triggering event may be one or more of unauthorized loss of main battery power, activation of an emergency button on the wireless device or destructive tampering of the wireless device. In response to the security triggering event the device enters into an emergency beacon mode. While in the emergency beacon mode the device first contacts emergency services and then sends an emergency beacon message to the emergency services. In preferred embodiments the device also obtains its current location and then uses the current location to construct at least a portion of the emergency beacon message.

In various embodiments destructive tampering includes the breaking of a hinge on the wireless device or the breaking away of a display portion or keyboard portion of the wireless device from the main body of the wireless device.

For preferred embodiments the unauthorized loss of main battery power includes removal of a battery from the wireless device without prior entry of a security personal identification number.

In another aspect a wireless telecommunications device is disclosed. The device includes a casing, an emergency button mounted on the casing, a wireless transceiver disposed in the casing, a global positioning system (GPS) receiver disposed in the casing, a memory disposed in the casing, a microprocessor disposed in the casing and communicatively connected to at least the memory, GPS receiver, and wireless transceiver; a main battery disposed in the casing for providing primary power to the microprocessor, memory, GPS receiver and wireless transceiver; and a secondary battery disposed in the casing that is inaccessible to a user for providing emergency backup power to the microprocessor, memory, GPS receiver and wireless transceiver. The memory stores program code executable by the microprocessor to cause the microprocessor to perform various steps. For example, the microprocessor monitors a security triggering event, which may be one or more of unauthorized loss of main battery power, activation of the emergency button or destructive tampering of the wireless device. If the microprocessor detects a security triggering event the microprocessor enters into an emergency beacon mode. While in the emergency beacon mode the microprocessor utilizes the wireless transceiver to establish a communications link with emergency services. The microprocessor utilizes the GPS receiver to obtain a position of the wireless device, and uses the position of the wireless device to construct at least a portion of an emergency beacon message. Finally, the microprocessor utilizes the communications link to send the emergency beacon message to the emergency services.

In some embodiments the main battery is connected to the microprocessor, memory, GPS receiver and wireless transceiver through the emergency button. In other embodiment the main battery is connected to the microprocessor, memory, GPS receiver and wireless transceiver through a hinge of the wireless device. In yet other embodiments the main battery is connected to the microprocessor, memory, GPS receiver and wireless transceiver through both a hinge of the wireless device and through the emergency button.

In preferred embodiments unauthorized loss of main battery power includes removal of the main battery from the casing prior to entry of a security personal identification number by the user. In other embodiments destructive tampering includes the detection of the breaking of a hinge on the wireless device or the breaking away of a display portion or keyboard portion of the wireless device from the casing of the wireless device.

Embodiment devices may be of use in almost all emergency event situations including but not limited to abduction, rape, murder, robbery, carjacking, fires, automobile accidents, household accidents, boating accidents, catastrophic events as well as benefit the sick and the elderly. Too often these events occur with no warning, and in a lot of cases, give an individual literally seconds to take action of any type. Preferred embodiment devices give people a way to be able to take advantage of those precious seconds that may be the difference between life and death.

Preferred embodiment systems and methods may be built into everyday telecommunication devices that are already in use worldwide, and as a result may create some doubt in the minds of violent criminals and may reduce a significant number of these crimes from occurring in the first place. In the event of an emergency situation taking place, embodiment devices may give authorities an exact time and location of the event, thus creating a more swift response time and potentially apprehending the perpetrator in less time than previous dial-up systems. Quicker response times may lead to more lives being saved. In essence the criminal would be calling the authorities on themselves by disabling the main battery power to various embodiment devices in any way. Various embodiments may thus create the ultimate crime fighter.

### BRIEF DESCRIPTION OF THE DRAWINGS

FIG. 1 is diagram of a first embodiment device.

FIG. 2 is diagram of a second embodiment device.

FIG. 3 is diagram of a third embodiment device.

FIG. 4 is a flow chart of an embodiment method.

### DETAILED DESCRIPTION

In the following specification preferred embodiments are integrated into wireless telecommunication devices at the manufacturing stages. For purposes of the following, a wireless telecommunication device encompasses all wireless telecommunication devices including, but not limited to, cellular, satellite, and home-based portable phones. To be in possession of the person holding it, embodiment devices may protect that person with a prerecorded message beacon which provides an important function: to send a distress signal identifying that there is an emergency at the location given through the GPS in the device. Preferred embodiment devices and methods are intended for personal security, and as a crime deterrent, and may integrate with existing emergency services systems to send an emergency beacon or the like to such systems.

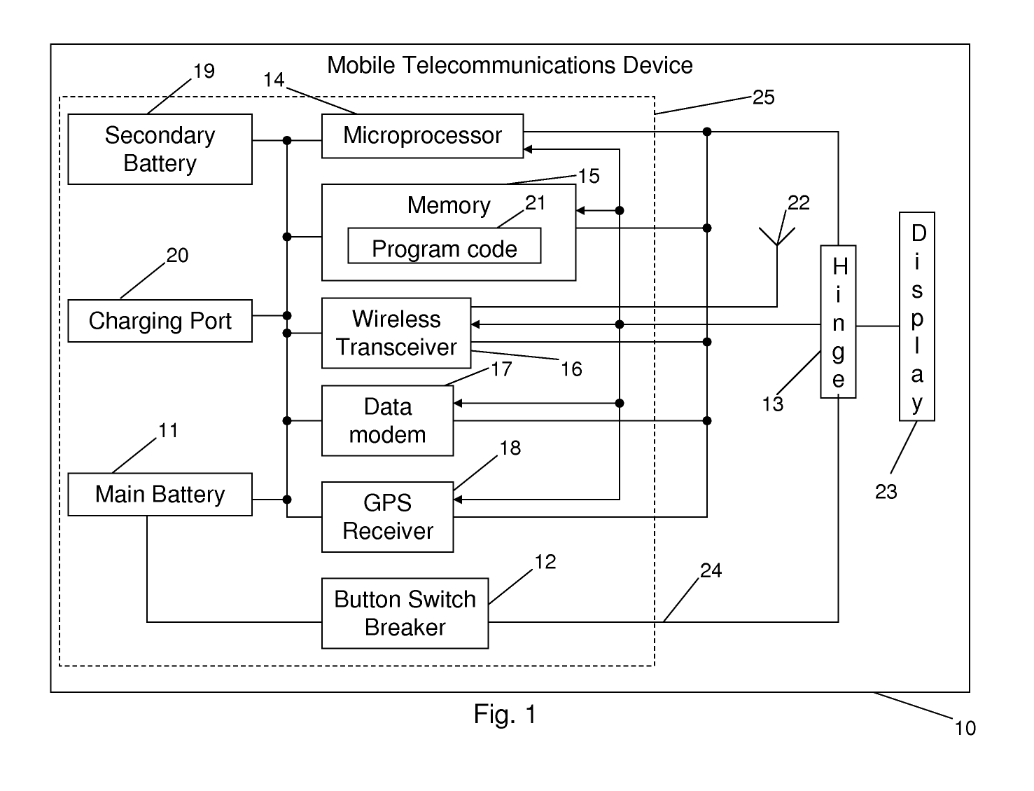

An embodiment device 10 is depicted in FIG. 1. The device 10 may be, for example, an otherwise standard portable telecommunication device, such as a cell phone, but augmented to perform an embodiment emergency beacon method. For example, the device 10 may be a clam-shell or slide-type cell phone having a hinge/slide 13 connecting the two halves of the cell phone together, as known in the art. Typically, one half may be a casing 25 that is the main body that contains the main battery 11, charging port 20, microprocessor 14, memory 15, wireless transceiver 16, data modem 17, GPS receiver 18 and may also include an antenna 22 which may be internal or external; however, the majority of personal wireless telecommunication devices manufactured today have internal antennas. The other half of the clam shell or slide device 10 will typically include a display 23. The main battery 11 is frequently, though not always, accessible to a user, as known in the art, so that the user may replace the main battery 11.

The embodiment device 10 is, however, modified to also provide security services to act as an emergency beacon. This modification includes a secondary battery 19 and an emergency button 12. The emergency button 12 is mounted on the casing 25. The secondary battery 19 is disposed within the casing 25 but is not accessible to the user for security purposes; that is, the typical user, without significant effort, such as the disassembly of the device 10, would not be able to easily gain access to the secondary battery 19. Further, main power provided by the main battery 11 is routed through the emergency button 12 and to the microprocessor 14, or to a power sensing circuit in communications with the microprocessor 14. Hence, the secondary battery 19 lies within the same shell or casing 25 as the processor 14, memory 15, wireless transceiver 16, GPS receiver 18, data modem 17 and antenna 23. As discussed earlier, the back-up, secondary battery 19 is preferably housed inside the wireless telecommunication device 10, and is not accessible from the main cover for security purposes.

The hinge/slide 13, if applicable, preferably has the main battery 11 power wire from the main battery 11 run through the emergency button 12, and then through the hinge/slide 13 to the microprocessor 14, or to suitable detection circuitry that is in communications with the microprocessor 14 for providing main power line information to the microprocessor 14. This can also be accomplished by running a micro switch or a small conduction device to show a break in current, as discussed below. In alternative embodiments the wiring to power the screen 23 may be set with a default that if the screen 23 lacks draw current the microprocessor 14 may sense this and enter into the emergency beacon mode.

With the above configuration, if the hinge/slide 13 is broken, the power carried to the microprocessor 14 by way of the main power wire 24 causes the processor 14 to detect a sudden drop in voltage or loss of power. However, critical components of the device 10, such as the processor 14, memory 15, wireless transceiver 16, data modem 17, GPS receiver 18, and antenna 22, will still obtain power from the secondary battery 19. Similarly, when a user activates the emergency button 12, main power from the main battery 11 is disrupted, which is detected by the microprocessor 14, and critical components fall back onto the secondary battery 19 power.

The emergency button/switch/breaker device 12 is preferably positioned on the rear outside case of the wireless telecommunication device 10. The button/switch/breaker 12 preferably provides a reasonable amount of physical resistance so as to avoid accidental activation or tripping, along the lines of a breaker with a definitive snap. In preferred embodiments the emergency button/switch/breaker 12 is easily accessible without the need to open the device 10 in order to summon emergency services. If the power is cut by button/switch/breaker 12, it can be reset by switching the button/switch/breaker back to standby and then restarting the device 10 by powering up as if the device 10 were just turned on.

The microprocessor 14 is communicatively connected to memory 15, as known in the art. The memory 15 includes program code 21 that is executable by the microprocessor 14 to control the functionality of the device 10. Such program code 21 may be substantially conventional in nature, as known in the art, but may further include additional instructions and data to perform embodiment security features. Specifically, the program code 21 causes the microprocessor 14 to detect loss of main power 11, and also detect an abrupt drop in voltage by way of a break in current from main power wire 24, such as by monitoring a signal pin indicative of main power 11, or the like. An abrupt drop in voltage is any drop that significantly exceeds what one would expect from normal battery drain. Any suitable logical connection may be employed, as known in the art, to permit the microprocessor 14 to detect loss of main power 11. Additionally, the program code 21 includes a security feature in which loss of main power 11, which may occur when, for example, the main battery 11 is being replaced without a security pin being entered prior to removal, or when the hinge/slide 13 is broken, or button 12 is pressed, will cause the microprocessor to execute an emergency beacon mode function, described below, which is also supported by the program code 21. The program code 21 also includes an additional security feature in which the emergency beacon function can be deactivated by the entering of a security personal identification number (PIN). For example, prior to replacing the main battery 11, the program code 21 may contain instructions that permits the user to enter a PIN; the successful input of this PIN will cause the device 10 to enter into a state such that it will not broadcast an emergency beacon when main battery 11 power is lost. This special state enables the user to replace main battery 11 without fear of creating any false alarms with emergency services personnel. This special state may last a predetermined amount of time, such as ten minutes or the like. Alternatively, the special state may be terminated by input from the user via a suitable user interface. Finally, the program code 21 may include special “power off” code that requires the entry of a valid PIN to turn off the device 10. If an incorrect PIN is entered the device 10 will remain on, such as in standby mode or the like, or even transition into the emergency beacon mode function.

As set forth above, the device 10 may typically enter into an emergency beacon mode when any of three events occur: 1) The main battery 11 is removed without entry of a satisfactory security PIN (i.e, an unauthorized loss of main battery 11 power); 2) The emergency button 12 is pressed; or 3) The hinge/slide 13 is broken away or damaged. In some embodiments, the device 10 may also 4) Enter into the emergency beacon mode when the user attempts to power the device 10 down, such as by pressing the power button, and when prompted enters an incorrect security PIN. In three of these scenarios (i.e., events (1), (2) and (3)) the main battery 11 power to wireless telecommunication device 10 may be abruptly lost. At this point the backup battery 19 is used by critical circuitry as a result of the main battery 11 power loss. By way of example, the microprocessor 14 or other power control circuitry may monitor the current draw of both batteries 11, 19 and when the main battery 11 power is lost the microprocessor 14 or power control circuitry may default exclusively to the secondary battery 19, which takes over the powering needs of critical components of the device 10 to set in motion the following events that result in an emergency message beacon being sent to emergency services.

To provide an emergency beacon, the microprocessor 14 signals to the memory 15, the data modem 17, and GPS receiver 18. The memory 15 is queried to find an emergency code to transmit dialing information, and an emergency message back to the microprocessor 14, which may be prerecorded, created by the microprocessor 14 using a software-based speech synthesizer, or both. The data modem 17 communicates with the microprocessor 14 to convert pertinent analog data to digital, and digital to analog, when necessary. Also, the GPS receiver 18, upon being activated by the microprocessor 14, communicates back to the microprocessor 14 the current location of the device 10, if available, or the last known good positional fix. The microprocessor 14 then sends to wireless transceiver 16 a call beacon through the antenna 22 to emergency services.

By way of example, to effect an emergency beacon the device 10 may dial a known emergency number, such as 911, to place a call. Once the call is answered, an announcement to the effect of “This is a priority cellular emergency” may be broadcast and then the most current GPS coordinates may be provided, such as by way of suitable text-to-speech algorithms. The device 10 may continue to place calls and let such calls ring until either emergency services pick up the call or the secondary battery 19 runs out of power. This all occurs automatically, and much faster than a user could do manually, and the device 10 may also accomplish this in total silence. In response to receiving the emergency beacon, emergency services personnel may be dispatched to the location provided by the GPS 18, or in the event of an abduction, will be able to track the assailants.

In preferred embodiments the device 10 will not activate due to normal main battery 11 drain. In such embodiments, the microprocessor 14 monitors the main battery 11 for a sudden drop in current, such as occurs upon activation of the emergency button 12, or by an unauthorized removal of the main battery 11 without the security pin entered prior to authorize such removal, or by a breaking of the hinge/slide 13, which holds main power wire 24. As discussed earlier, any suitable combination of software and hardware, as known in the art may be employed to permit the processor 14 to detect such sudden drops of main battery 11 power.

In preferred embodiments the memory 15 contains sufficient information to permit the device 10 to contact a suitable emergency services provider, such as a 911 number or the like. This may be entered at the manufacturing stage. Alternatively, the program code 21 may implement a suitable user interface to permit the user to enter an emergency contact information such as a medic-alert user. The “beacon” itself is the call sent to emergency services with a computer generated voice advising of an emergency situation, the time and the most current GPS 18 coordinates, which may be generated by suitable program code 21.

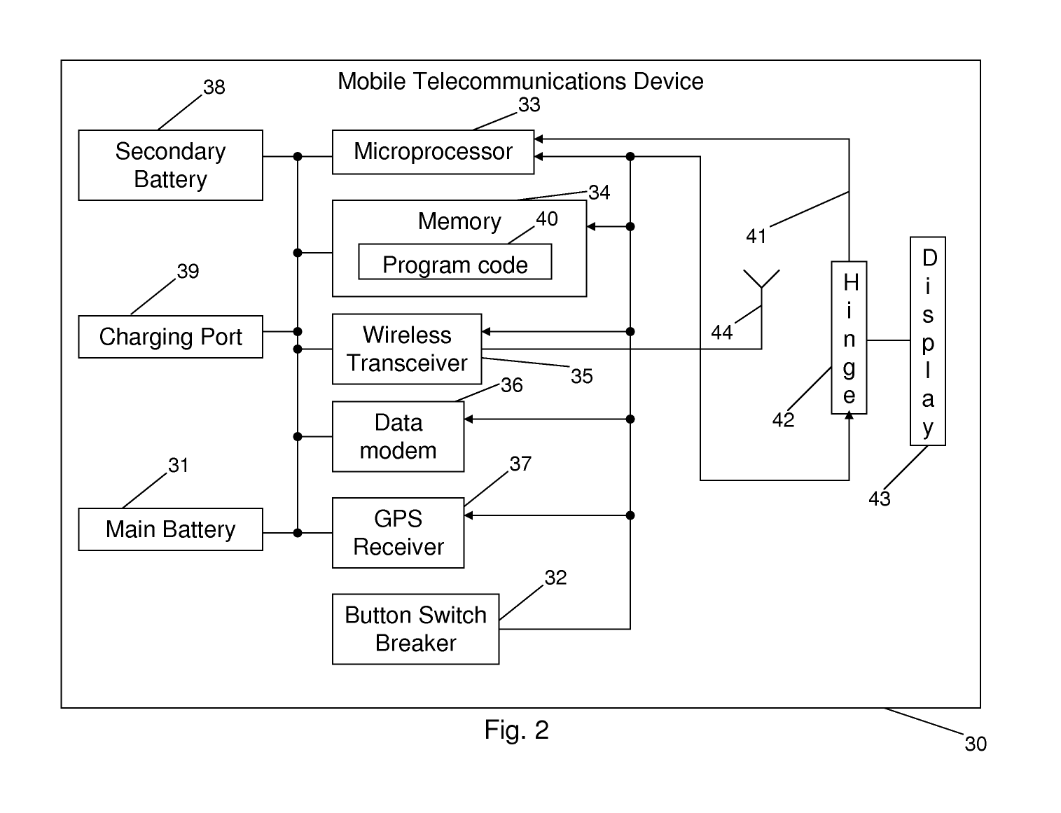

Another embodiment device 30 is depicted in FIG. 2. The device 30 may be, for example, an otherwise standard portable telecommunication devise, such as a cell phone, but augmented to perform an embodiment emergency beacon method. As discussed above, the device 30 may be a clam shell or slide-type cell phone having a hinge/slide 42 connecting the two halves of the cell phone together, as known in the art.

The embodiment device 30 is modified to also serve as an emergency beacon. This modification includes a secondary battery 38 and an emergency button 32, as in the previous embodiment 10. The secondary battery 38 lies within the same shell or casing as the processor 33, memory 34, wireless transceiver 33, GPS receiver 37, and antenna 44 and is not accessible from the main cover for security purposes. In this embodiment, rather than having all power from the main battery 31 routed through the hinge/slide 42, the hinge/slide 42 instead has power and data wires 41 running from the main bus or processor 33 to the display 43 and back to the processor 33. In this embodiment the wiring for power and data to the screen 43 can be monitored by the microprocessor 33, and if the microprocessor 33 detects that power or data communications with the display 43 has been lost, indicating that the display 43 has been broken away from the main body of the device 30, the microprocessor 33 will cause the device 30 to enter into its emergency beacon mode. The microprocessor 33 may detect this directly or via intermediary circuits. It will be appreciated that this tampering detection method may be used for other components as well, such as for a keyboard on the device 30.

With the above configuration, if the hinge is broken, the power, data or both carried to the display 43 is detected by the microprocessor 33 by way of the display power and data wire 41 through the hinge/slide 42 from a drop in voltage to, or communications with, the display 43. However, critical components of the device 30, such as the processor 33, memory 34, wireless transceiver 35, data modem 36, GPS receiver 37, and antenna 44, will continue to receive power from the main battery 31. Similarly, when a user activates the emergency button 32, main power from the main battery is not disrupted, but instead a standard button-press signal is detected by the microprocessor 33, which upon detection causes the device 30 to enter into the emergency beacon mode. However, in the event of loss of main battery power 31, as in the previous embodiment 10, critical components may fall back onto the secondary battery 38 power.

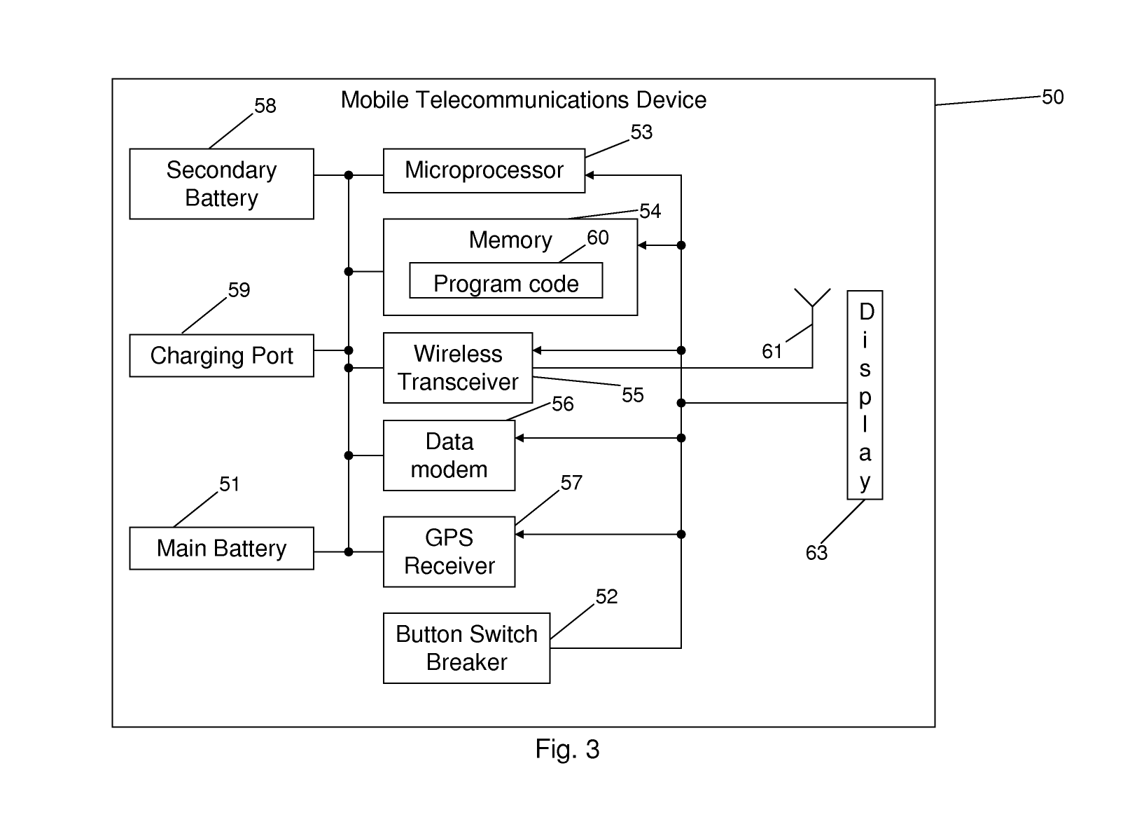

Yet another embodiment device 50 is depicted in FIG. 3. The device 50 may be, for example, an otherwise standard portable telecommunication devise, such as a cell phone, but augmented to perform an embodiment emergency beacon method, and which is not a clam-shell or slide-type cell phone and thus does not have a hinge. Typically, the device 50 may contain the main battery 51, charging port 59, microprocessor 53, memory 54, wireless transceiver 55, data modem 56, GPS receiver 57 and may also include an antenna 61 which may be internal or external, however, the majority of personal wireless telecommunication devices manufactured today have internal antennas.

The embodiment device 50 is however, modified to also serve as an emergency beacon. This modification includes a secondary battery 58 and an emergency button 52. Power routing may be performed as in the above embodiments. For example, main battery 51 power may all route directly through the emergency button 52 so that when emergency button 52 is depressed all main battery 51 power is lost, which is detected by microprocessor 53 using any suitable means, and the device 50 then relies exclusively on the secondary battery 58 when entering into the emergency beacon mode. Alternatively, the emergency button 52 may not cause a disruption of main battery 51 power but instead simply sends a button-press signal that is detected by the microprocessor 53 using any suitable means, such as a PIO line, to then cause the device 50 to enter into the emergency beacon mode. Similarly, the microprocessor 53 may detect loss of power or communications with the display 63 and in result thereof enter into the emergency beacon mode. At any time, upon unauthorized failure of the main battery 51 power, the device 50 may use the secondary battery 58 to power mission-critical circuitry, such as the microprocessor 53, memory 54, wireless transceiver 55, data modem 56 and GPS receiver 57. The back-up, secondary battery 58 is preferably housed inside the wireless telecommunication device 50, and is not accessible from the main cover for security purposes. Similarly, when the main battery 51 is removed without a proper security pin (thus triggering an unauthorized power loss), critical components may fall back onto the secondary battery 58 power to effect the emergency beacon function.

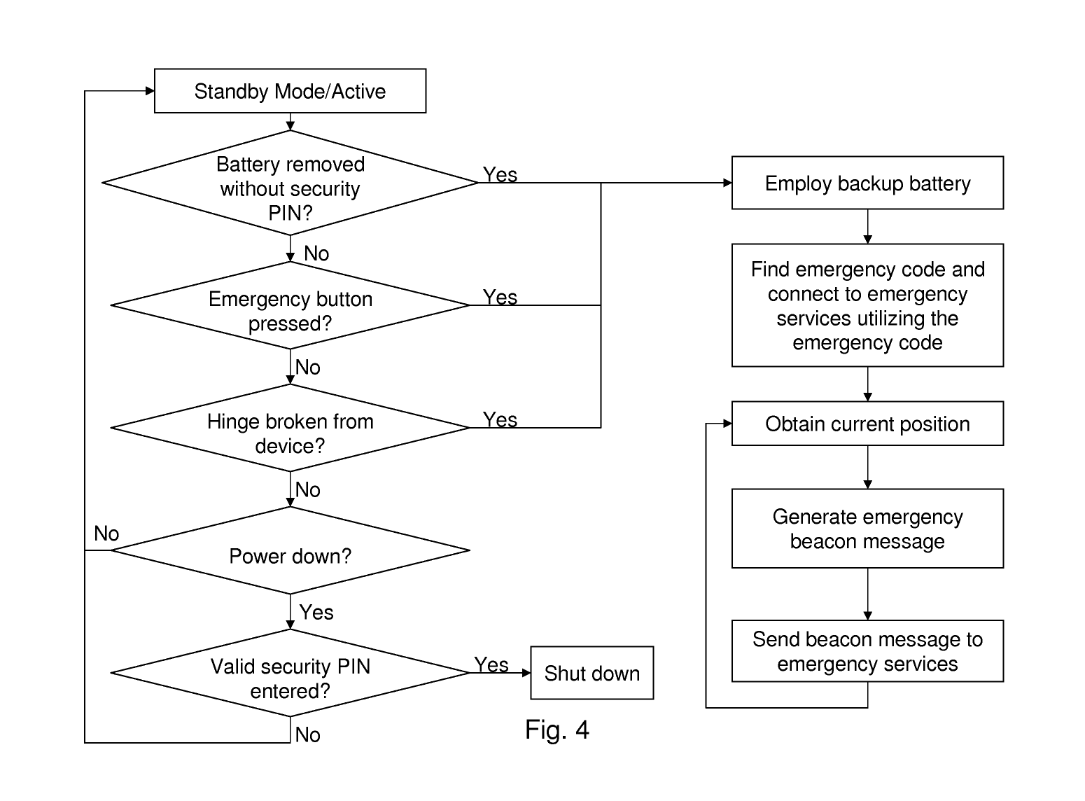

FIG. 4 is a flow chart of security services method steps performed in an embodiment wireless telecommunications device. As indicated above, the steps may be performed by any suitable combination of hardware and software within the portable telecommunications device. Generally, the device will remain in an active or standby mode. For example, the device may be “active” when placing a phone call or exchanging data with another device, such as with a cell tower. The device may be in a standby mode when it is not active, but remains powered on by the user. While in either of these modes the device may monitor any of three security triggering events that will cause the device to enter into an emergency beacon mode.

First, the device may detect unauthorized loss of main battery power, such as the removal of the main battery without the prior entry of a valid security PIN or the otherwise abrupt loss of main battery power prior to entry of a valid security PIN. If this occurs then the device triggers into the emergency beacon mode, discussed below. If not, then the device may further detect if an emergency button has been pressed. As discussed above, these steps may be conflated if all main battery power is disrupted by the pressing of the emergency button. If the emergency button has been pressed, then the device will enter into the emergency beacon mode. The device may also detect if it has been severely tampered with, such as the breaking of a hinge that connects a clamshell device together, the breaking away of the display from the main body, the breaking away of the keyboard from the main body, etc. Again, if such destructive tampering is detected then the device will enter into the emergency beacon mode. Finally, the device monitors power off requests, such as the pressing of a power button, a shut-down command or the like. If there is no power-down request the device remain in the active/standby state. When the user requests the device to be powered down, the device prompts the user for a PIN. If a valid PIN is entered the device then shuts down in a standard manner. If, however, an invalid PIN is entered the device does not power down but instead remains in the active/standby state. As discussed earlier, in some embodiments the device may transition into the emergency beacon mode if an invalid PIN is entered during a power down request. Otherwise, the device remains in the standby/active mode and continues to check for these emergency beacon mode triggering events and power down requests.

When the device enters into the emergency beacon mode it first employs a backup battery to ensure that operations continue regardless of the status of the main battery; the backup battery may be used in addition to the main battery if main battery power is available. The device then looks for an emergency code at which emergency services may be contacted, such as 911 or the like, and utilizes this emergency code to establish a communications link with the emergency services, such as by dialing the emergency code number to establish a telephonic link. While establishing contact with emergency services, the device also attempts to determine its current location, or obtain its last known position. The device then constructs an emergency beacon message. This message may include, for example, a predetermined message combined with the current position information or last good fix information; the message may also include the current time, for example, or any other suitable information. The device sends this emergency beacon message to emergency services via the communications link. The device may remain in the emergency beacon mode until it runs out of main power and secondary power, or until, for example, a security PIN is entered. While in the emergency beacon mode the device continuously searches for its current position, constructs an appropriate emergency beacon message and then transmits the constructed message to emergency services over the communications link.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A security services method for a wireless device, the method comprising:
monitoring a security triggering event comprising one or more of unauthorized loss of main battery power, activation of an emergency button on the wireless device or destructive tampering of the wireless device;
in response to the security triggering event entering into an emergency beacon mode, the emergency beacon mode comprising:
contacting emergency services; and
sending an emergency beacon message to the emergency services.

2. The security services method of claim 1 wherein the emergency beacon mode further comprises obtaining a current location of the wireless device and utilizing the current location to construct at least a portion of the emergency beacon message.

3. The security services method of claim 1 wherein the destructive tampering comprises breaking of a hinge on the wireless device or breaking away of a display portion or keyboard portion of the wireless device from a main body of the wireless device.

4. The security services method of claim 1 wherein the unauthorized loss of main battery power comprises removal of a battery from the wireless device without prior entry of a security personal identification number.

5. The security services method of claim 1 wherein the security triggering event further includes entry of an invalid personal identification number when attempting to power down the wireless device.

6. A wireless telecommunications device comprising:
a casing;
an emergency button mounted on the casing;
a wireless transceiver disposed in the casing;
a global positioning system (GPS) receiver disposed in the casing;
memory disposed in the casing;
a microprocessor disposed in the casing and communicatively connected to at least the memory, GPS receiver, and wireless transceiver;
a main battery disposed in the casing for providing primary power to the microprocessor, memory, GPS receiver and wireless transceiver; and
a secondary battery disposed in the casing and inaccessible to a user, the secondary battery providing emergency backup power to the microprocessor, memory, GPS receiver and wireless transceiver;
wherein the memory comprises program code executable by the microprocessor to cause the microprocessor to perform the following steps:
monitor a security triggering event comprising one or more of unauthorized loss of main battery power, activation of the emergency button or destructive tampering of the wireless device;
in response to the security triggering event entering into an emergency beacon mode, the emergency beacon mode comprising:
utilizing the wireless transceiver to establish a communications link with emergency services;
utilizing the GPS receiver to obtain a position of the wireless device;
utilizing the position of the wireless device to construct at least a portion of an emergency beacon message; and
utilizing the communications link to send the emergency beacon message to the emergency services.

7. The wireless telecommunications device of claim 6 wherein the main battery is connected to the microprocessor, memory, GPS receiver and wireless transceiver through the emergency button.

8. The wireless telecommunications device of claim 6 wherein the main battery is connected to the microprocessor, memory, GPS receiver and wireless transceiver through a hinge of the wireless device.

9. The wireless telecommunications device of claim 6 wherein unauthorized loss of main battery power comprises removal of the main battery from the casing prior to entry of a security personal identification number.

10. The security services method of claim 6 wherein the destructive tampering comprises detection of breaking of a hinge on the wireless device or breaking away of a display portion or keyboard portion of the wireless device from the casing of the wireless device. cm 11. The security services method of claim 6 wherein the program code further causes the microprocessor to perform the following steps:
in response to a power down request prompting the user for a personal identification number;
determining if the personal identification number is valid; and
shutting down the device only if the personal identification number is valid.
